(19) United States
(12) Patent Application Publication
(10) Pub. No.: US 2014/0337044 A1
(43) Pub. Date: Nov. 13, 2014

(54) Detecting and Identifying Erroneous Medical Abstracting and Coding and Clinical Documentation Omissions

(71) Applicant: Daniel Heinze, San Diego, CA (US)

(72) Inventor: Daniel Heinze, San Diego, CA (US)

(73) Assignee: GNOETICS, INC., San Diego, CA (US)

(21) Appl. No.: 14/230,580

(22) Filed: Mar. 31, 2014

Related U.S. Application Data
(60) Provisional application No. 61/822,589, filed on May 13, 2013.

(51) Int. Cl. G06Q 50/22; G06Q 10/10

(52) U.S. Cl. CPC G06Q 50/22; G06Q 10/10
USPC 705/2

(57) ABSTRACT

A method and computer program product for implementing a clinical documentation, code and abstract errors and omissions detector and characterizer (the “code error detector”) are disclosed. Concepts represented in the linguistic surface forms of clinical text data source documents are mapped onto an ontology being indexed as component codes and reference codes where component codes index primitive concepts and reference codes index fully-defined concepts that are produced as linguistic cognitive grammar compositions of the primitive concepts that are indexed by the component codes. Fully-defined concepts indexed by some codes and representing either some standard for required clinical document content or an externally derived mapping of the document content to fully-defined concepts in the ontology are mapped to the ontology as source codes. The fully-defined concepts indexed by the source codes are decomposed, in the ontology, to their primitive concepts. Using measures of compositionality, semantic distance and entailment, the fitness of the concepts indexed by the source codes as proxies for the fully-defined concepts indexed by the reference codes is determined. Further, the distance between the concepts indexed by the source codes and the concepts indexed by the reference codes is characterized in terms of the distances of individual primitive concepts as indexed by component codes. In this manner a measure of fitness is further characterized in terms of particular primitive concepts. The method disclosed may be implemented using a variety of ontology specification and reasoning methods, but it is here described as an implementation using a novel modification to L-space ontology whereby concepts are represented in L-space as data types and the saliences of data types are represented as continuous real values greater than 0 and less than 1 such that the integral or summation of the saliences of all data types in a domain equals 1. Given the mapping of some data type indexed by reference code and the mapping of some data type indexed by source code on the same ontology, the code error detector determines the semantic distance between the reference code data type and any source code data type with respect to component code data types. The distance, as a measure of the fitness of the source code data type as a proxy for the reference code data type with respect to the component code data type(s), is stored and reported.

### CLAIM OF PRIORITY

This application claims priority under 35 USC §119(e) to U.S. Patent Application Ser. No. 61/822,589, filed on May 13, 2013, the entire contents of which are hereby incorporated by reference.

### CROSS-REFERENCE TO RELATED APPLICATIONS

Utility Patent Application: A Method and Computer Program Product for Implementing Indexed Natural Language Processing; Inventor: Daniel T. Heinze, San Diego, Calif.; Assignee: Gnoetics, Inc., San Diego, Calif.

### STATEMENT REGARDING FEDERALLY SPONSORED RESEARCH OR DEVELOPMENT

Not Applicable

### REFERENCE TO SEQUENCE LISTING, A TABLE, OR A COMPUTER LISTING COMPACT DISK APPENDIX

Not Applicable

### TECHNICAL FIELD

The following disclosure relates to methods and computerized tools for detecting and identifying clinical documentation omissions and erroneous medical coding and abstracting using natural language processing (NLP) based information extraction from medical records and analysis of such extracted information as compared to clinical documentation standards and/or the clinical codes submitted by medical providers for reporting and billing purposes.

### BACKGROUND OF THE INVENTION

The quality of clinical documentation and the thoroughness and accuracy of discrete information that is extracted from such documentation is critical to the management of the practice of clinical medicine. In the United States, a variety of efforts such as Clinical Documentation Improvement (CDI) and Meaningful Use (MU) define necessary content of clinical documentation for select disease types and therapies. Further, the majority of bills for medical services are created by the process of mapping the description of medical conditions and services, as documented by the medical provider in the clinical documentation, to a set of alpha-numeric medical codes, each of which codes represents a particular medical finding, diagnosis, service, treatment or procedure. The description of medical conditions and services, as documented by the medical provider, is, in the industry, referred to as “clinical documentation” or just “documentation” and hereafter in this application, as “documentation” which documentation is represented by “documents”. The mapping of the concepts expressed in documentation to codes is, in the industry, referred to as “abstracting”, “medical coding” or just “coding”, and hereafter in this application, is referred to as “coding” with the product of coding being “code(s)”. The definition of each finding, diagnosis, service, treatment, or procedure, or of any component part thereof is a “concept”. The creation of a bill for medical services or the creation of a report regarding clinical practice using codes is, in the industry referred to as “medical billing”, “billing” or “reporting” and hereafter in this application, are referred to as “reporting” with the product of reporting being “report(s)” which reports are composed as a set of codes.

When coding is performed for use in billing, the process is, in the industry and hereafter in this application, referred to as “coding for billing”. Overbilling occurs when coding inaccuracies (whether unintentional or intentional) result in codes that represent medical services of a higher value than what the documentation actually describes. Overbilling of this nature is, in the industry and hereafter in this application, referred to as “errors”. When the documentation fails to contain all of the information as specified by some documentation standard, this results in “omissions”. The detection and identification of errors and omissions is essential to the prevention of error, fraud and abuse in medical coding and billing and to the assurance of clinical document quality. “Errors” and “omissions” will be considered synonymous with regard to the method and implementation of the invention here described and which method and implementation will be referred to as the “code error detector”.

### SUMMARY OF THE INVENTION

Techniques for detecting and identifying abstracting and coding errors and documentation omissions are disclosed. While the following describes techniques in context of medical coding and abstracting and are particularly exemplified with respect to the detection of fraud and abuse in the context of coding and the detection of omissions in documentation, some or all of the disclosed techniques can be implemented to apply to any text or language processing system in which the accurate mapping of information from an expression to a standardized representation, terminology or ontology is required.

In one aspect, documents in electronic form are received to perform natural language processing (NLP) of the documents wherein the NLP processor extracts information and automatically performs coding by mapping the concepts represented in the input documents (the “source documents”) onto an ontology as a codes that index the primitive concepts that are expressed in the document, where codes indexing primitive concepts are referred to as “component codes”. The concepts indexed by component codes whose source is in the documents are composed into fully-defined concepts per the constraints imposed by the grammar of the document and by the ontology. Fully-defined concepts derived in this manner from the document are indexed by “source codes”. Fully-defined concepts composed of primitive concepts indexed by component codes as derived from some standard set of medical concepts are also mapped and are indexed by “reference codes”.

The relations between concepts (both primitive and fully-defined) represented in the ontology include, but are not limited to, compositionality (including logical composition, semantic composition and linguistic surface form composition), specificity, meronomy, salience and necessity. By compositionality, the component code concepts are related to the reference code and source code concepts of which the component code concepts are components. Compositional relations are specific to the types of components that are being related. A finding such as a fracture will have an anatomic site such as the femur (a long bone of the thigh), a type such as open or closed, and several other components. By specificity, component code, reference code and source code concepts are represented as L-space data types [Heinze, 1994] and are hierarchically related according to specificity by means of is-a links in a graph (for example, the concepts for “finger”, “first finger”, “first finger of left hand” are of increasing specificity). By meronomy, concepts are related as part to whole (for example, “finger” is part of “hand”). Salience is the probability distribution over some set of compositional relations between concepts. Necessity is the measure of how necessary the presence of a component is to a fully defined concept. Using the previous example of a fracture, salience will define the probability distribution over the set of anatomical sites where fractures can occur such that a “femur fracture” is more probable than a “liver fracture”, and a “closed femur fracture” is more probable than an “open femur fracture”. Also, by necessity, the type “open” must be specifically mentioned whereas for a “closed femur fracture”, “closed” is not required to be specifically mentioned in the clinical document and may be assumed. Given these relations between the component codes, the reference codes and the source codes, compositional analysis determines if each source code concept (for example “open femur fracture”) is appropriately supported by a set of component codes that map to one or more reference code concepts (finding “fracture”, anatomic site “femur”, type “open”) which component concepts are determined to be or not to be linguistically associated by NLP. Over a sample set of source documents and source codes from a particular provider, compositionality, specificity, meronomy, salience and necessity data can be used as analysis features in order to detect and identify patterns of up-coding, fraud and abuse by comparison to the reference codes.

Implementations can optionally include one or more of the following features. Identifying the absence in some source document of any component code that is necessary to a source code. Identifying, in some source document, source code component codes that are present but that are not syntactically or pragmatically associated with the other component codes that are composed to form the source code (for example, in the sentence “the patient fractured his femur when he fell into an open pit”, the component code concept for “open femur fracture” would be inappropriate because the component code concept “open”, though appearing proximate to “femur fracture”, is syntactically structured so as to describe the “pit”, not the “fracture”). Identifying, in some source document, source code component codes that are underspecified (i.e. lack the necessary level of specificity) with respect to the component code concepts (for example, for the phrase “fracture of the leg bone”, the component code concept for “femur fracture” would be over-specified because the component code concept “leg bone” is underspecified with respect to the component code concept “femur”). Identifying, in some source document, source code component codes that are over-specified (i.e. exceed the level of specificity) with respect to the component codes (for example, for the phrase “avulsion fracture of the first finger”, the source code concept for “finger fracture” would be underspecified because the component code concept “avulsion fracture” is over-specified with respect to the component code concept “fracture”). Identifying, in some source document, source code component codes that are incorrect by meronomy that is appropriate to the component code concepts (for example, for the phrase “fracture of the first finger”, the component code for “hand fracture” would be incorrect by meronomy because although the component code for concept “first finger” is, by meronomy, a part of the component code for concept “hand”, there is a separate reference code for “finger fracture”). Identifying, in some source document, source code component codes that lack the salience (for example, for source code concept “open femur fracture”, the statement “I explored the femur fracture site” would be clearly inadequate whereas the statement “I explored the wound at the femur fracture site” may be adequate because by salience exploration of a wound at a fracture site carries a high probability that the fracture is open, whereas simple exploration of the site carries only a low probability that the fracture is open). Identifying, in some source document, source codes that, though they are acceptable by compositionality, specificity, meronomy and salience, lack the support of a component code that is required by necessity (for example, many medical codes have documented requirements that the medical coder is not permitted to make even obvious medical inferences (for example, some document may state that “the patient has a temperature of 101 degrees Fahrenheit”, but unless the clinician states that the patient has a “fever”, by necessity, it is not permitted to assign the code for “fever”).

Implementations can further optionally include one or more of the following features. Processing the source document can include normalizing the source document text data to a predetermined text format; morphologically processing the normalized text data to a standardized format; identifying one or more phrases in the morphologically processed text data to be converted to another standardized format; identifying the part of speech of each term within the document; identify one or more possible syntactic categories of each term and punctuation mark within the document; identifying one or more syntactic parses for each phrase or sentence within the document; identifying one or more syntactic relations between the terms and punctuation within each phrase or sentence within the document; eliminating one or more syntactic relations between the terms and punctuation within each phrase or sentence within the document based on compositionality, specificity, meronomy, salience and necessity; identifying anaphoric references within the document, and; identifying pragmatic relationships between concepts within the document. All of these tasks listed in this paragraph can be achieved using techniques that are well known to those practiced in the art and science of NLP, computational linguistics and theoretical linguistics, and the implementations of said techniques can include but are not limited to one or more manually specified techniques including but not limited to rules or ontologies, or by one or more statistical or machine learning techniques such as but not limited to support vector machines, conditional random fields, Bayesian networks, latent semantic indexing.

Implementations can also optionally include one or more of the following features. Composing component codes so as to form reference codes. Comparing reference codes to source codes. Calculating a measure of semantic distance, based on compositionality, specificity, meronomy, salience and necessity, between a reference code and a source code. So analyzing a statistically significant sample of documents and their source codes (the “sample set”) from a provider in order to detect regular patterns of incorrect coding. Identifying particular errors in compositionality, specificity, meronomy, salience and necessity that produce regular patterns of incorrect coding in a sample set. Identifying one or more subsets of documents in a sample set that evidence particular errors in compositionality, specificity, meronomy, salience and necessity. Organizing the identified error data according to type and source code. Storing the raw and organized error data (including but not limited to error type, associated documents, location of each error in each document, individual and composite measures of semantic distance, occurrence time errors, and errors by provider) in electronic and or printed form. Presenting the raw and organized error data for human review and analysis in the form of electronic or printed reports, including dynamic presentations in which the human reviewer can make display and reporting selections including but not limited to the error data under review, the relations between the types of error data, and the style and organization of display.

These aspects can be implemented using an apparatus, a method, a system, or any combination of an apparatus, methods, and systems. The details of one or more embodiments are set forth in the accompanying drawings and the description below. Other features, objects, and advantages will be apparent from the description and drawings, and from the claims.

### BRIEF DESCRIPTION OF THE DRAWINGS

FIG. 1A is a functional block diagram of a code error detector system.

FIG. 1B is a functional block diagram of a code error detector system executing on a computer system.

FIG. 1C is a detailed view of a code error detector application.

FIG. 2 is a flow chart of a grammatical analysis system.

FIG. 3 is a flow chart showing a detailed view of a code error assessor system.

FIG. 4 is a flow chart showing a detailed view of an ontology distance application.

Like reference symbols in the various drawings indicate like elements.

### DETAILED DESCRIPTION OF THE INVENTION

Techniques for detecting and identifying abstracting and coding errors and documentation omissions are disclosed. While the following describes techniques in context of medical coding and abstracting and are particularly exemplified with respect to the detection of fraud and abuse in the context of medical coding for billing or omissions in clinical documentation, some or all of the disclosed techniques can be implemented to apply to any text or language processing system in which the conceptual content of the documents or utterances are to be measured against some standard set of concepts.

Various implementations of compositional NLP are possible. The implementation of techniques for compositional NLP used in the method for code error detector are based in and include, but are not limited to, the use of under-specified syntax as embodied in NLP software systems developed by Gnoetics, Inc. and in commercial use since 2009 and the L-space semantics as published in Daniel T. Heinze, “Computational Cognitive Linguistics”, doctoral dissertation, Department of Industrial and Management Systems Engineering, The Pennsylvania State University, 1994. Building on the techniques embodied or described in these sources, techniques for detecting and identifying erroneous coding for billing by means of up-coding for medical services as described in clinical documentation are disclosed.

In some aspects, the code error detector techniques as described in this specification are designed to be implemented in conjunction with (and may be dependent on) methods of measuring and characterizing the semantic distance between a reference code and a source code. Any competent method for so measuring and characterizing semantic distance between concepts may be employed without departing from the spirit and scope of the claims. However, in particular, code error detector techniques can be implemented to function with techniques described in Heinze, 1994, as noted above and which in the method and application here disclosed are extended by one or more novel enhancements.

Code Error Detector System Design

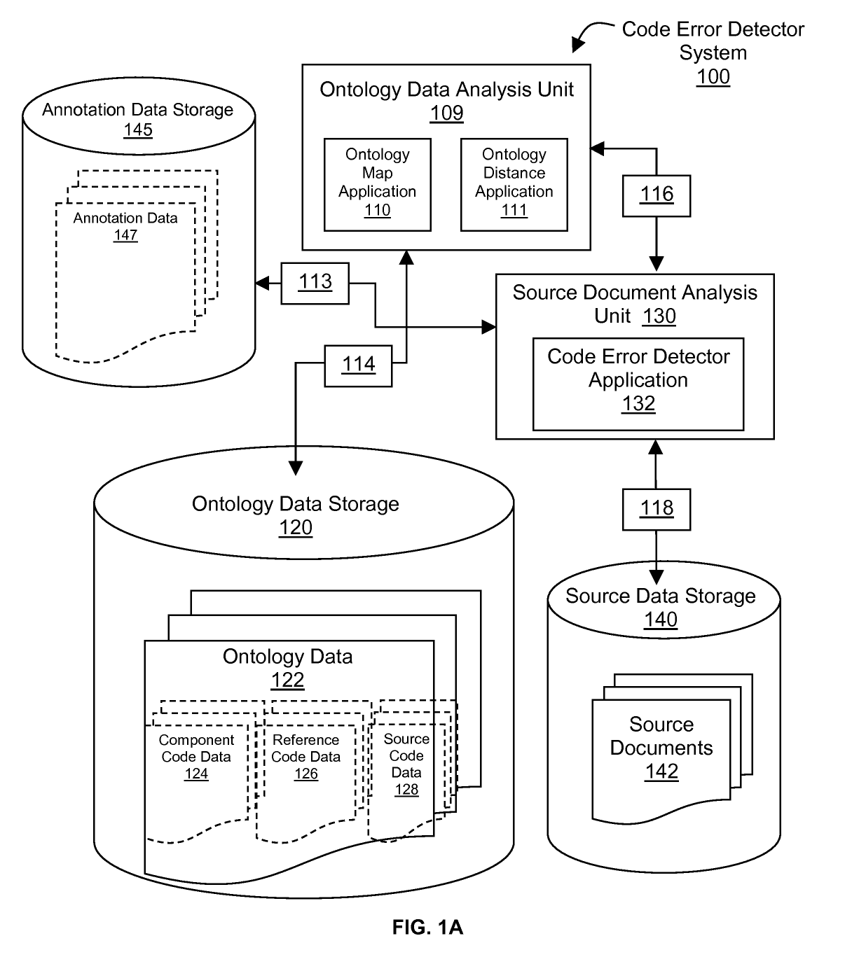

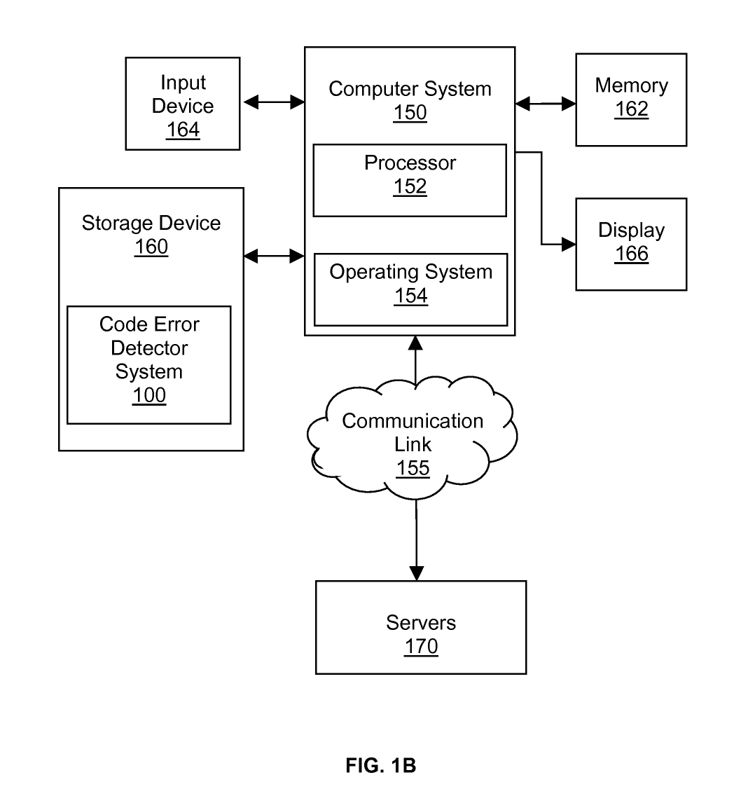

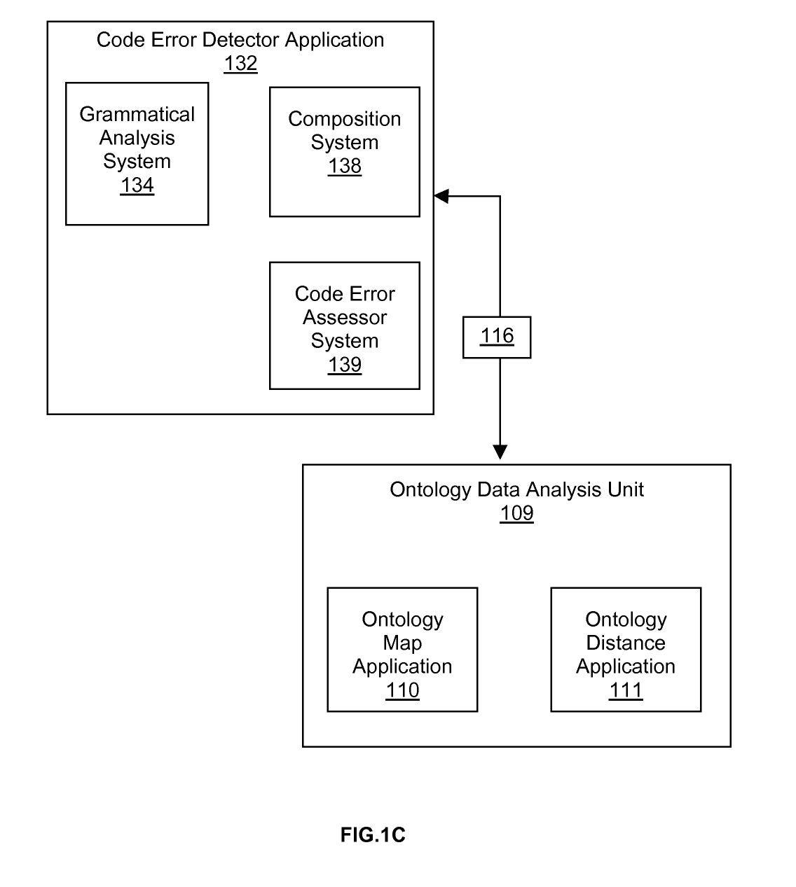

FIG. 1A is a functional diagram of a code error detector system 100. The code error detector system 100 includes a code error detector application 132. The code error detector application 132 can be implemented as a part of a source document analysis unit 130. The source document analysis unit 130 and the code error detector application 132 are communicatively coupled to annotation data storage 145, source data storage 140 and ontology data analysis unit 109 through bi-directional communication links 113, 118 and 116 respectively. Source data storage 140 is implemented to store source documents 142 and source codes 143. Annotation data storage 145 is implemented to store annotation data 147. Ontology data analysis unit 109 is coupled to ontology storage 120 through bi-directional communication link 114. Ontology storage 120 is implemented to store ontology data 122. Ontology data 122 may include component code data 124, reference code data 126 and source code data 128.

FIG. 1B is a block diagram of code error detector system 100 implemented as software or a set of machine executable instructions executing on a computer system 150 such as a local server in communication with other internal and/or external computers or servers 170 through communication link 155, such as a local network or the internet. Communication link 155 can include a wired and/or a wireless network communication protocol. A wired network communication protocol can include local wide area network (WAN), broadband network connection such as Cable Modem, Digital Subscriber Line (DSL), and other suitable wired connections. A wireless network communication protocol can include WiFi, WIMAX, BlueTooth and other suitable wireless connections.

Computer system 150 includes a central processing unit (CPU) 152 executing a suitable operating system (OS) 154 (e.g., Windows® OS, Apple® OS, UNIX, LINUX, etc.), storage device 160 and memory device 162. The computer system can optionally include other peripheral devices, such as input device 164 and display device 166. Storage device 160 can include nonvolatile storage units such as a read only memory (ROM), a CD-ROM, a programmable ROM (PROM), erasable program ROM (EPROM) and a hard drive. Memory device 162 can include volatile memory units such as random access memory (RAM), dynamic random access memory (DRAM), synchronous DRAM (SDRAM) and double data rate-synchronous DRAM (DDRAM). Input device 164 can include a keyboard, a mouse, a touch pad and other suitable user interface devices. Display device 166 can include a Cathode-Ray Tube (CRT) monitor, a liquid-crystal display (LCD) monitor, or other suitable display devices. Other suitable computer components such as input/output devices can be included in or attached to computer system 150.

In some implementations, code error detector system 100 is implemented as a web application (not shown) maintained on a network server (not shown) such as a web server. Code error detector system 100 can be implemented as other suitable web/network-based applications using any suitable web/network-based computer programming languages. For example Java, C/C++, an Active Server Page (ASP), and a JAVA Applet can be implemented. When implemented as a web application, multiple end users are able to simultaneously access and interface with code error detector system 100 without having to maintain individual copies on each end user computer. In some implementations, code error detector system 100 is implemented as a local application executing in a local end user computer or as client-server modules, either of which may be implemented in any suitable programming language, environment or as a hardware device with the application's logic embedded in the logic circuit design or stored in memory such as PROM, EPROM, Flash, etc.

Code Error Detector Application

FIG. 1C is a detailed view of code error detector application 132, which includes grammatical analysis system 134, composition system 138 and code error assessor system 139. Code error detector application 132 interacts with ontology data analysis unit 109 through bi-directional communication link 116. Grammatical analysis system 134 can be implemented using a combination of finite state automata (FSA) and syntax parsers including but not limited to context-free grammars (CFG), context sensitive grammars (CSG), phrase structure grammars (PSG), head-driven phrase structure grammars (HPSG), or dependency grammars (DG), which can be implemented in Java, C/C++ or any complete programming language and may be configured manually or from training examples using machine learning. Composition system 138, ontology map application 110 and ontology distance application 111 can be implemented in Java, C/C++ or any complete programming language.

Grammatical Analysis System Algorithm

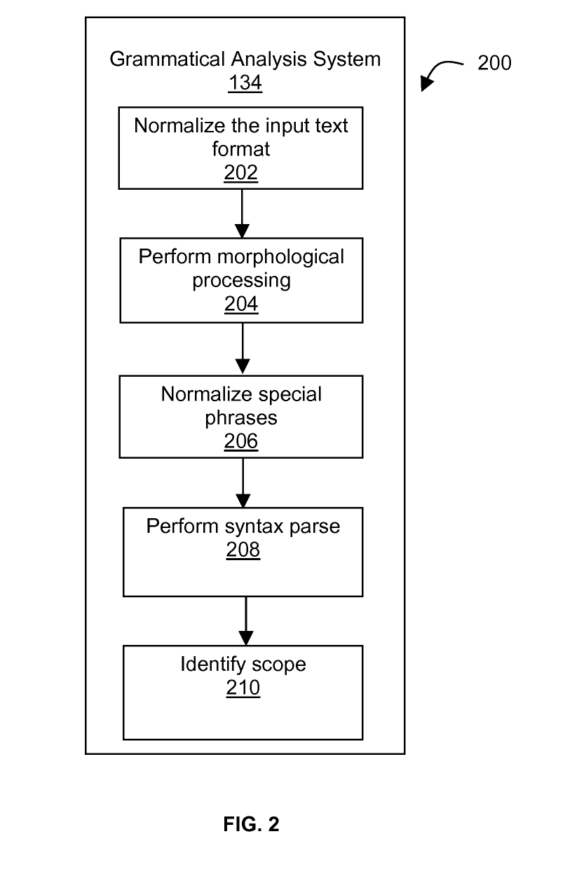

FIG. 2 is a flow chart of process 200 for implementing grammatical analysis system 134. Given each source input text document from documents 142, which includes words, numbers, punctuations and white or blank spaces to be parsed, parse item bounding system 134 begins by normalizing the document to a standardized plain text format at 202. Normalizing to a standardized plain text format can include converting the document, which may be in a word processor format (e.g., Word®), XML, HTML or some other mark-up format, to a plain text using either ASCII or some application dependent form of Unicode. The normalization process also includes annotating the byte offsets of the beginning and ending of document sections, headings, white space, terms and punctuation so that any mappings to ontology data 122, or specifically to reference code data 124 or possible code data 126, can be mapped back to the original location in source documents 142.

The normalized input text is morphologically processed at 204 by morphing the words, numbers, acronyms, etc. in the input text to one or more predetermined standardized formats. Morphological processing can include stemming, normalizing units of measure to desired standards (e.g. SAE to metric or vice versa) and contextually based expansion of acronyms. The normalized and morphologically processed input text is processed to identify and normalize special words or phrases at 206. Special words or phrases that may need normalizing can include words or phrases of various types such as temporal and spatial descriptions, medication dosages, or other application dependent phrasing. In medical texts, for example, a temporal phrase such as “a week ago last Thursday” can be normalized to a specific number of days (e.g., seven days) and an indication that it is past time.

At 208, the grammatical analysis system 134 is implemented to perform syntax parse 208 of the normalized input text and identify the syntactic categories of each term and punctuation, the scope of phrases, the scope of clauses, and the syntactic features of each including but not limited to phrase heads and dependencies. The syntax parse data are stored as annotations for use in ensuing processes. In some implementations, the data structure for representing the annotations includes arrays, trees, graphs, stacks, heaps or other suitable data structure that maintains a view of the generated annotations that can be mapped back to the location of the annotated item in source documents 142. Annotation data 147 produced by grammatical analysis system 134 are stored in annotation data storage 145.

As a refinement to the annotations produced by perform syntax parse 201, identify scope 210 produces further annotation data 147 that identifies the syntactic scope within which terms and punctuation may be combined and for attempted mapping to the ontology data 122 as reference code data 124 and possible code data 126 by ontology map application 110.

Ontology Map Application Algorithm

Ontology map application 110 maps terms from within each source document 142 phrase that has been identified and annotated by grammatical analysis system 134 onto individual instances within component code data 124 and also maps grammatically scoped groups of component code data 124 to reference code data 126. The mapping algorithm may be one or more of a variety of mapping or categorization algorithms including but not limited to those based on string matching, inverted indexes, regular expression matching, term vector matching, forward-chaining rules, backward-chaining rules, latent semantic indexing, support vector machines, conditional random fields, hidden Markov models and neural networks. Maps from source documents 142 to component code data 124 and from component code data 124 to reference code data 126 are stored as annotation data 147 in annotation data storage 145.

Composition System Algorithm

Composition building system 138 accesses the annotations produced by grammatical analysis system 134 from annotation data storage 145 through bi-directional communications link 113 and, within each scope and governed by standard rules of grammar, forms combinations of component code data 124 that are mapped onto reference code data 126 governed by ontology map application 110. Maps from the source documents 142 to component code data 124 are stored as annotation data 147 in annotation data storage 145.

In some implementations, from annotation data storage 145 and through bi-directional communications link 113, the composition system 138 accesses annotations produced by grammatical analysis system 134 and annotations of component code data 124 and reference code data 126. Governed by standard linguistic rules of pragmatics and discourse analysis, component code data 124 and reference code data 126 are further composed to form further reference code data 126.

Code Error Assessor System Algorithm

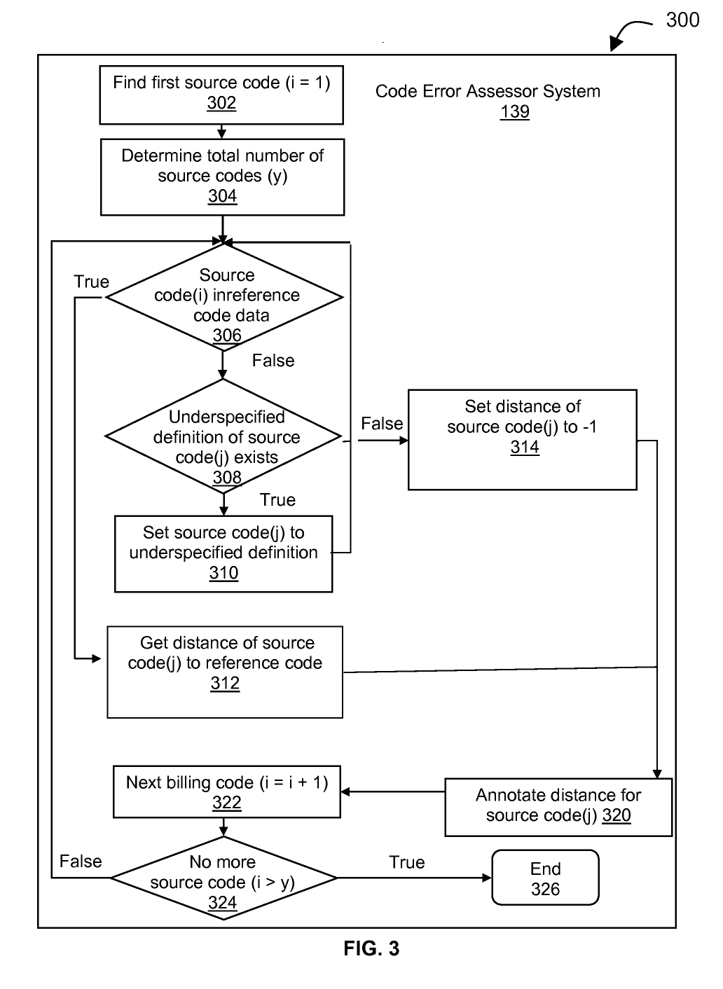

FIG. 3 is a flow chart of process 300 for implementing code error assessor system 139. Given a set of source code data 128 in which the number of source codes is greater than zero, find first source code(j=1) 302. Determine the total number of source codes(y) 304. Test for source code(j) in reference code data 306. If test 306 is false, test for underspecified definition of source code(j) exists 308. Test 308 is performed by searching ontology data 122 for ancestors of source code(j). By definition of ontology data 122, the root of the ontology is mutually exclusive from the definition of any reference code in reference code data 126, source code in source code data 128 or component code in component code data 124. If test 308 is false, this means that neither the source code(j) nor any underspecified ancestor is in reference code data 126, therefore set distance to source code(j) to −1 (or some other suitable value) to indicate that there is no evidence for source code(j) in reference code data 126 (in L-space terms this indicates “separation”). If test 308 is true, set source code(j) to underspecified definition 310 and again perform test 306. The purpose is to produce an iteration over all the underspecified ancestors of the source code(j), but for readability, some obvious steps that would be obvious to any practitioner have been omitted in the flowchart. If test 306 is true, then get distance of source code(j) to the reference code in reference code data 126 by passing source code(j) as data type D and reference code as data type D′ to ontology distance application 111. Ontology distance application 111 will return a value greater than or equal to 0 where 0 indicates that source code(j) is fully justified (in L-space terminology, this is an “identity”) and a value greater than 0 indicates, in L-space terms, that the underspecified definition covers source code(j) by “inclusion”. As annotation data 147 in annotation data storage 145, annotate distance for source code(j) 320 as the distance specified in 312 or 314. Get next source code(j=j+1) 322. Test if no more source code (j>y) 324. If test 324 is false, then continue processing at test 306. If test 324 is true, then end 326.

Ontology Distance Application Algorithm

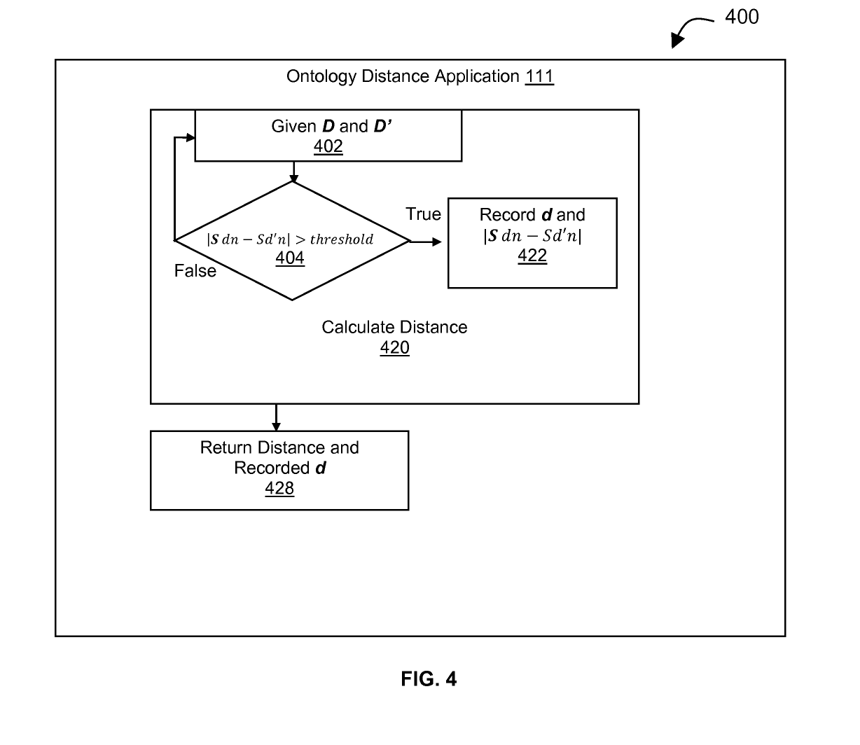

FIG. 4 is a flow chart of process 400 for implementing ontology distance application 111. Ontology distance application 111 calculates an L-space distance between source code(j) and some reference code where source code(j) is the index of data type D in source code data 128 in ontology data 122 and reference code is the index of data type D′ in reference code data 126 in ontology data 122. Given D and D′ 402, calculate distance 420 as ∫ₙ|S dn−S d′n|. At each d, if |S dn−S d′n|> threshold 404 is true, then record d and |S dn−S d′n| 422 as annotation data 147 in annotation data storage 145, else if false, then continue. Upon completion of calculate distance 420, return distance and recorded d 428 as annotation data 147 in annotation data storage 145.

With regard to calculate distance 420, the L-space definitions as given in [Heinze, 1994] are here extended by the novel modification that salience is changed from being valued 0 to 1 inclusive to being a real value greater than 0 and less than 1 where the integral (in a continuous implementation) or the sum (in a discrete implementation) of the saliences of data types d₁ to dₙ, given d₁+d₂+ . . . +dₙ=D or d₁×d₂× . . . ×dₙ=D, sum to 1 (for example, form a Gaussian distribution) and where d₁ to dₙ form a continuous cover of all ontological values. The effects of these changes are that there is a continuous monotone function ƒ: D→D′ between any pair of data types and that a metric of the semantic distance between any pair of data types is measurable and comparable. In some instantiations, data types d element of D and with salience below some threshold T may be unimplemented for the sake of computational tractability. In such instantiations, T is set such that the contribution of any unimplemented d with salience less than Twill have an effect on function ƒ: D→D′ that is inconsequential in the application.

The particular function ƒ: DΘD′ that is employed to measure semantic distance for any particular instantiation will be application specific but will be of the general form ∫ₙ |S dn−S d′n| which is the integral over n of the absolute value difference of the salience between dₙ and d′ₙ.

In some instantiations, ontology distance application 111 may, in addition to calculating the value difference of the salience between dₙ and d′ₙ may also record and report all d where the distance is greater than an application specific threshold T′.

In some instantiations, ontology distance application 111 may approximate the integral as a summation over n.

Computer Implementations

In some implementations, the techniques for implementing code error detector as described in FIGS. 1A to 4 can be implemented using one or more computer programs comprising computer executable code stored on a computer readable medium and executing on code error detector system 100. The computer readable medium may include a hard disk drive, a flash memory device, a random access memory device such as DRAM and SDRAM, removable storage medium such as CD-ROM and DVD-ROM, a tape, a floppy disk, a CompactFlash memory card, a secure digital (SD) memory card, or some other storage device.

In some implementations, the computer executable code may include multiple portions or modules, with each portion designed to perform a specific function described in connection with FIGS. 1A to 4 above. In some implementations, the techniques may be implemented using hardware such as a microprocessor, a microcontroller, an embedded microcontroller with internal memory, or an erasable programmable read only memory (EPROM) encoding computer executable instructions for performing the techniques described in connection with FIGS. 1A to 4. In other implementations, the techniques may be implemented using a combination of software and hardware.

Processors suitable for the execution of a computer program include, by way of example, both general and special purpose microprocessors, and any one or more processors of any kind of digital computer, including graphics processors, such as a GPU. Generally, the processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

A number of embodiments have been described. Nevertheless, it will be understood that various modifications may be made without departing from the spirit and scope of the claims. Accordingly, other embodiments are within the scope of the following claims.

What is claimed is:

1. A method comprising:
creating an ontology of component code data being linguistic surface forms mapped to logical and semantic primitive concepts;
creating an ontology of reference code data being compositions of component code data;
receiving documents in the form of text data;
receiving source code data intended to represent some content of the received documents;
automatically extracting component code data from the received documents;
mapping source code data onto the reference code data in terms of the component code data;
measuring the distance between the source code data and the reference code data in terms of the component code data;
assessing the specificity of the source code data with respect to the reference code data in terms of the component code data;
characterizing the measured distance and specificity of the source code data with respect to the reference code data in terms of the component code data;
annotating and reporting the distance measure and specificity assessment as an indication of source code data correctness against some specified standard;

2. A method of implementing claim 1 comprising:
creating component code data and reference code data in L-space ontology form;
receiving text data document;
processing document to generate one or more data types Dᵢ in an L-space;
receiving one or more a priori data types Dⱼ in an L-space;
iteratively identifying each data type xⱼ IN Dᵢ and xⱼ IN Dⱼ and measuring the functional space xⱼ→xᵢ=mᵢⱼ;
measuring the functional space Dⱼ→Dᵢ=Mᵢⱼ;
comparing each measure mᵢⱼ against some application specific set of thresholds tᵢⱼ to determine the acceptability of each x; as a surrogate of xⱼ;
comparing the measure Mᵢⱼ against some application specific set of thresholds Tᵢⱼ to determine the acceptability of Dᵢ as a surrogate of Dⱼ; and
identifying and reporting any short-comings in mᵢⱼ as judged by threshold tᵢⱼ.

3. The method of claim 2, wherein processing the text data document comprises:
normalizing the text data document to a predetermined normalized text data format;
morphologically processing the normalized text data to a standardized format;
identifying one or more phrases in the morphologically processed text data to be converted to another standardized format;
Identifying the syntactic categories and relations between one or more phrases in the text data;
identifying the scope within which concepts within the syntactic categories and relations of the text data may modify other concepts within the text data;
identifying and mapping primitive data types within a scope to primitive data types within an ontology; and
coordinating primitive semantic data types into complex data types per the governing syntax of the input document and the semantic logic represented in the ontology.

4. The method of claim 2 wherein the L-space definition is modified such that the salience of data types is represented as continuous real values greater than 0 and less than 1 such that the integral or summation of the saliences of all data types in a domain equals 1.

5. The method of claim 2 wherein measuring the functional space Mᵢⱼ depends on the method of claim 4.

6. The method of claim 2, wherein iteratively identifying each data type xᵢ IN Dᵢ and xⱼ IN Dⱼ and measuring the functional space xⱼ→xᵢ=mᵢⱼ comprises:
for each pair xᵢxⱼ calculate mij=∫ₙ|Sxᵢn−Sxⱼn|;
record {xᵢ xⱼ, mᵢⱼ}.

7. The method of claim 2, wherein measuring the functional space Dⱼ→Dᵢ=Mᵢⱼ comprises:
Mᵢⱼ=0;
for each {xᵢ xⱼ, mᵢⱼ} Mᵢⱼ=Mᵢⱼ+mᵢⱼ.

8. The method of claim 2, wherein comparing each measure mᵢⱼ against some application specific set of thresholds tᵢⱼ to determine the acceptability of each xᵢ as a surrogate of xⱼ comprises:
if mᵢⱼ>tᵢⱼ then accept xᵢ as a surrogate of xⱼ

9. The method of claim 2, wherein comparing the measure Mᵢⱼ against some application specific set of thresholds Tᵢⱼ to determine the acceptability of Dᵢ as a surrogate of Dⱼ comprises:
if Mᵢⱼ>Tᵢⱼ then accept Dᵢ as a surrogate of Dⱼ

10. The method of claim 2, wherein identifying and reporting any short-comings in mᵢⱼ as judged by threshold tᵢⱼ comprising:
if not Mᵢⱼ>Tᵢⱼ then
for each {xᵢ xⱼ, mᵢⱼ} where not mᵢⱼ>tᵢⱼ report {xᵢ xⱼ, mᵢⱼ}.

11. A computer program product, encoded on a computer-readable medium, operable to cause data processing apparatus to perform operations comprising:
receiving text data;
processing the text data to generate one or more data types Dᵢ in an L-space;
receiving one or more a priori data types Dⱼ in an L-space;
iteratively identifying each data type xᵢ IN Dᵢ and xⱼ IN Dⱼ and measuring the functional space xⱼ→xᵢ=mᵢⱼ;
measuring the functional space Dⱼ→Dᵢ=Mᵢⱼ;
comparing the measure Mᵢⱼ against some application specific set of thresholds Tᵢⱼ to determine the acceptability of Dᵢ as a surrogate of Dⱼ;
comparing each measure mᵢⱼ against some application specific set of thresholds tᵢⱼ to determine the acceptability of each xᵢ as a surrogate of xⱼ; and
identifying and reporting any short-comings in mᵢⱼ as judged by threshold tᵢⱼ.

12. The computer program of claim 11, wherein processing the text data comprises:
normalizing the text data to a predetermined text format;
morphologically processing the normalized text data to a standardized format;
identifying one or more phrases in the morphologically processed text data to be converted to another standardized format;
Identifying the syntactic categories and relations between one or more phrases in the parsed text data;
identifying the scope within which concepts within the parsed text data may modify other concepts within the parsed text data;
identifying and mapping primitive data types within a syntactic scope to primitive data types within an ontology; and
coordinating primitive semantic data types into complex data types per the governing syntax of the input document and the logic represented in the ontology.

13. The computer program product of claim 11, wherein the L-space definition is modified such that the salience of data types is represented as continuous real values greater than 0 and less than 1 such that the integral or summation of the saliences of all data types in a domain equals 1.

14. The computer product of claim 11, wherein measuring the functional space Mᵢⱼ depends on the computer product of claim 13.

15. The computer product of claim 11, wherein iteratively identifying each data type xᵢ IN Dᵢ and xⱼ IN Dⱼ and measuring the functional space xⱼ→xⱼ=mᵢⱼ comprises:
for each pair xᵢxⱼ calculate mij=∫ₙ|Sxᵢn→Sxⱼn|;
record {xᵢ xⱼ, mᵢⱼ}.

16. The computer product of claim 11, wherein measuring the functional space Dⱼ→Dᵢ=Mᵢⱼ comprises:
Mᵢⱼ=0;
for each {xᵢ xⱼ, mᵢⱼ} Mᵢⱼ=Mᵢⱼ+mᵢⱼ.

17. The computer product of claim 11, wherein comparing each measure mᵢⱼ against some application specific set of thresholds tᵢⱼ to determine the acceptability of each xᵢ as a surrogate of xⱼ comprises:
if mᵢⱼ>tᵢⱼ then accept xᵢ as a surrogate of xⱼ

18. The computer product of claim 11, wherein comparing the measure Mᵢⱼ against some application specific set of thresholds Tᵢⱼ to determine the acceptability of Dᵢ as a surrogate of Dⱼ comprises:
if Mᵢⱼ>Tᵢⱼ then accept Dᵢ as a surrogate of Dⱼ

19. The computer product of claim 11, wherein identifying and reporting any short-comings in mᵢⱼ as judged by threshold tᵢⱼ comprising:
if not Mᵢⱼ>Tᵢⱼ then
for each {xᵢ xⱼ, mᵢⱼ} where not mᵢⱼ>tᵢⱼ report {xᵢ xⱼ, mᵢⱼ}.
